(19) United States
(12) Patent Application Publication
(10) Pub. No.: US 2008/0174081 A1
(43) Pub. Date: Jul. 24, 2008

(54) Pushcart

(75) Inventor: Chang-Yao Wu, Taipei (TW)

Correspondence Address: Venable LLP;Raymond J. Ho, 575 7th Street NW, Washington, DC, 20004-1601, US

(73) Assignee: Test Rite International Company, LTD., Taipei City (TW)

(21) Appl. No.: 11/785,825

(22) Filed: Apr. 20, 2007

(30) Foreign Application Priority Data
Jan. 24, 2007 (TW) 096102611

(51) Int. Cl. B62B 3/00

(52) U.S. Cl. 280/47.34; 188/2 R

(57) ABSTRACT

The present invention provides a pushcart having a rotatable push bar disposed between a first support strut and a second support strut as well as a plurality of braking assemblies connecting to the push bar. By applying a force on the push bar, the braking assemblies release wheels disposed below a base plate, thereby moving the pushcart. On the contrary, by releasing the push bar, the braking assemblies stop the wheels, thereby stopping the pushcart. When not using the pushcart, the push bar and the base plate are folded and stored, thereby saving storage space and enhancing convenience.

### BACKGROUND OF THE INVENTION

1. Field of the Invention

The present invention relates to a pushcart, particularly to a pushcart capable of braking.

2. Description of the Prior Art

Referring to FIG. 9, a conventional pushcart 90 includes a push bar 91, a base plate 92, wheels 93 and support struts 94. Each of the wheels 93 is provided on a bottom of the base plate 92, while the two support struts 94 are disposed at each of two ends on top of a side of the base plate 92. The push bar 91 and an auxiliary bar are then provided between the two support struts 94. When transporting objects using the pushcart 90, the to-be-transported objects are piled up on the base plate 92 of the pushcart 90 and are transported to the destination by pushing the push bar 91. However, when moving objects to the base plate 92, it is not possible to fix the pushcart 90 at a particular location and prevent it from sliding, especially on an unleveled road surface. In this way, the user has to tightly grasp the push bar 91 so as to keep the pushcart 90 at the original location while moving objects onto the base plate 92, making the use of pushcart 90 inconvenient. When moving objects on unleveled locations, the pushcart may slide downward, because the user has to remove his/her hand from the push bar 91 of the pushcart 90 so as to move objects onto the base plate 92, thereby making the use of the pushcart 90 inconvenient. Additionally, if objects are to be carried to several destinations, the pushcart 90 often has to be carefully stopped on a stable ground for temporarily unloading the objects midway, in order to prevent the pushcart 90 from sliding.

In addition to the above drawbacks of the conventional design, after using the pushcart 90, the pushcart 90 has to be properly folded and stored so as to save storage space. Consequently, improvements should be made to the conventional pushcart 90, such that the pushcart is capable of braking, folding and storage.

### SUMMARY OF THE INVENTION

The primary object of the present invention is to provide a pushcart capable of easily controlling braking or moving, such that a braking assembly is released by applying a force on a first push bar, moving the pushcart. When releasing the first push bar, the braking assembly comes into contact with wheels of the pushcart, thereby preventing the wheels from moving and stopping the sliding movement of the pushcart. Additionally, another object of the present invention is to provide a pushcart capable of folding and storage.

To achieve the above objects, the pushcart includes a base plate for carrying an object; a plurality of wheel assemblies are disposed below the base plate and include a plurality of wheels; a first support strut and a second support strut, being hollow and disposed on two ends of the base plate; a first push bar disposed between the first support strut and the second support strut; and a first braking assembly, having at least a first wiring and a first spring. The first wiring includes a first end and a second end, wherein the first end is disposed on the first push bar, and the second end is connected to a first brake pad. The first wiring is provided on the inside of the hollow first support strut, while the first spring is disposed between the first brake pad and the wheel assembly, thereby moving or stopping the pushcart.

According to a preferred embodiment of the present invention, a second braking assembly includes at least a second wiring and a second spring, wherein the second wiring includes a third end and a fourth end. The third end is provided on the first push bar, whereas the fourth end is connected to a second brake pad. The second wiring is provided on the inside of the hollow second support strut, whereas the second spring is provided between the second brake pad and the wheel assembly.

According to another preferred embodiment of the present invention, the pushcart includes a pivotal member, which is pivotally connected to the first push bar and is connected to the first wiring thereon. The pivotal member is an eccentric sleeve that is pivotally connected to the first push bar. A slot is then provided on an eccentric position of the eccentric sleeve, such that the slot is pivotally connected to the first wiring.

According to another preferred embodiment of the present invention, the first braking assembly further includes a connecting assembly to be connected to the first wiring and the first brake pad.

According to another preferred embodiment of the present invention, the wheel assembly includes a wheel holder, and the first spring is disposed between the first brake pad and the wheel holder of the wheel assembly.

According to another preferred embodiment of the present invention, the first brake pad is provided on the wheel holder of the wheel assembly.

According to another preferred embodiment of the present invention, the pushcart further includes a second push bar, which is provided between the first support strut and the second support strut.

According to another preferred embodiment of the present invention, at least one bearing is provided between the wheel assembly and the base plate.

According to another preferred embodiment of the present invention, the base plate, having a first portion and a second portion, is pivotally connected to the first portion and the second portion via a pivotal assembly, wherein the pivotal assembly is a hinge.

According to another preferred embodiment of the present invention, the pushcart further includes a pedal assembly, which is provided on the first portion. The pedal assembly includes a locating member provided below the base plate; a control member provided below the base plate; and a locating lock connecting to the control member. By controlling the control member, the locating lock is located on the locating member, such that the first portion and the second portion of the base plate are folded by using the pivotal assembly.

According to another preferred embodiment of the present invention, the locating member is provided on the second portion and is extended below the first portion. The locating member has an opening for inserting into the locating lock.

According to another preferred embodiment of the present invention, the pedal assembly further includes a pedal frame, and the control member further includes a pedal, having an end pivotally connected to the pedal frame; a first wiring and a second wiring, wherein the second wiring includes a first portion and a second portion, such that the first portion is connected to the pedal, and the second portion is connected to the locating lock.

According to another preferred embodiment of the present invention, the pushcart further includes a first strut, which is disposed below the first portion and includes an opening for inserting into the locating lock; and a second strut, which is disposed below the first portion and includes an opening for inserting into the locating lock.

According to another preferred embodiment of the present invention, the locating lock further includes a second spring disposed between the first strut and the second strut.

According to another preferred embodiment of the present invention, the pedal assembly further includes a roller for changing the direction of the second wiring.

In this way, the present invention has the advantages of braking the pushcart without applying any force on the first push bar, moving the pushcart by applying a force on the first push bar, and folding and storing the pushcart after using it.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic perspective view of the pushcart made according to the present invention.

FIG. 2 shows a cross-sectional schematic view along the A-A line of FIG. 1.

FIG. 3 is a cross-sectional schematic view showing the pressing of the pushcart along the A-A line of FIG. 1.

FIG. 4 shows a side schematic view of the pushcart made according to the present invention.

FIG. 5 is a side schematic view showing folding of the pushcart made according to the present invention.

FIG. 6 shows a cross-sectional schematic view along the B-B line of FIG. 1.

FIG. 7 is a schematic view showing the pedal assembly of the pushcart made according to the present invention.

FIG. 8 is a schematic view showing the actions of the pedal assembly of the pushcart made according to the present invention.

FIG. 9 shows a schematic perspective view of a conventional pushcart.

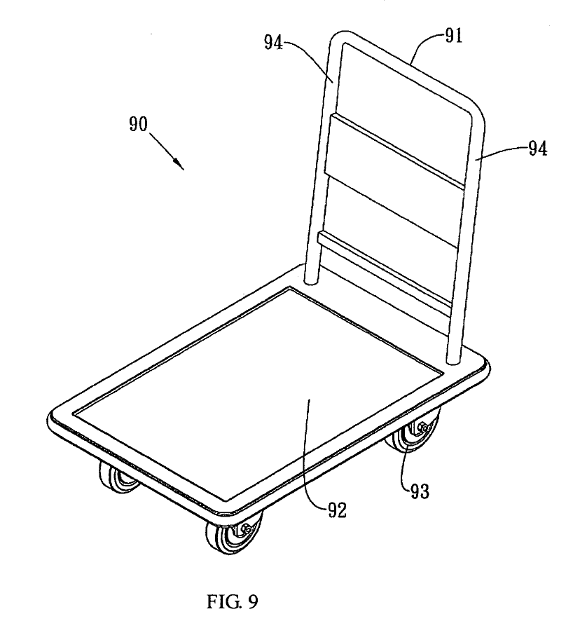

### DETAILED DESCRIPTION OF THE PREFERRED EMBODIMENTS

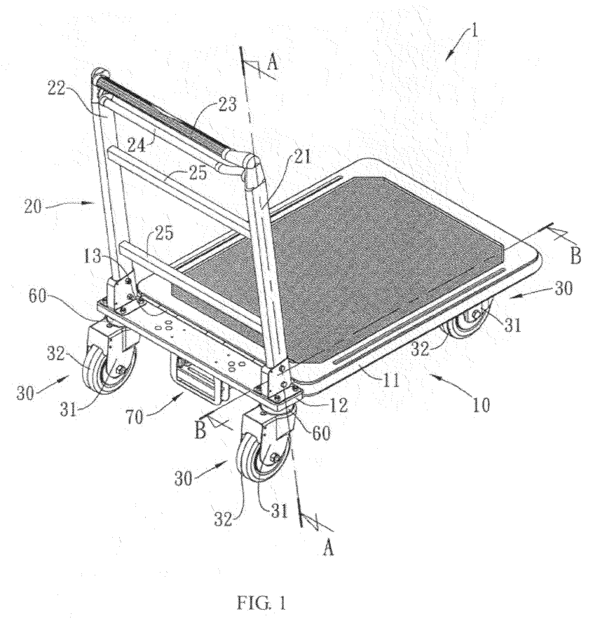

Referring to FIG. 1, the pushcart 1 of the present invention includes a base plate 10, a push bar assembly 20, a plurality of wheel assemblies 30, a braking assembly 40 and a pedal assembly 70. The base plate 10 includes a first portion 12, a second portion 11 and a pivotal assembly 13. The pivotal assembly 13 is pivotally connected to the first portion 12 and the second portion 11. Each of the wheel assemblies 30 is provided below the base plate 10. Preferably, four wheel assemblies 30 are respectively disposed on the inside of four corners of the rectangular base plate 10. The push bar assembly 20 is disposed at a side of the two ends of the first portion 12 of the base plate 10, and the pedal assembly 70 is provided below the first portion 12 of the base plate 10, thereby controlling the folding and storage of the pushcart 1. The braking assembly 40 is disposed between the base plate 10 and each of the wheel assemblies 30. By using the push rod assembly 20, the braking assembly 40 can control the movement or braking of the pushcart 1.

The pivotal assembly 13 is preferably a hinge or a pivotal shaft body or an equivalent structure that can be rotatably and pivotally connected to the first portion 12 and the second portion 11 of the base plate 10.

Each of the wheel assemblies 30 includes a wheel holder 31 and a wheel 32, being both disposed below the base plate 10. A bearing 60 is provided between the first portion 12 of the base plate 10 and each of the wheel assemblies 30, such that movement direction of the pushcart 1 can be freely controlled. The push bar assembly 20 includes a first support strut 21 and a second support strut 22, which are hollow shaft bodies respectively disposed on the two ends of the first portion 12 of the base plate 10. An auxiliary bar 25 is provided between the first support strut 21 and the second support strut 22, while the first push bar 23 and the second push bar 24 are both connected to the two ends of the first support strut 21 and the second support strut 22.

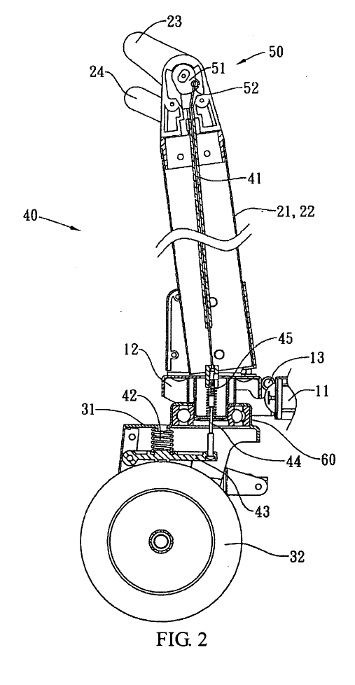

Referring to FIG. 2, the first braking assembly 40 includes a first wiring 41, a first spring 42 and a first brake pad 43, whereas the second braking assembly includes a second wiring, a second spring and a second brake pad (the second braking assembly is made of the same structures as those of the first braking assembly; not shown in the figure). The first wiring 41 and the second wiring are respectively disposed inside the hollow shaft body of the first support strut 21 and the second support strut 22. The first wiring 41 is connected to an end side of the first push bar 23, while the second wiring is connected to another end side of the first push bar 23. Another end of the first wiring 41 is connected to a first brake pad 43 so as to actuate the first brake pad 43, while another end of the second wiring is connected to a second brake pad to actuate the second brake pad. The first brake pad 43, which is movably disposed on the wheel holder 31, comes into contact with or becomes separated from the wheel 32. Likewise, the second brake pad, which is movably disposed on the wheel holder, comes into contact with or becomes separated from the wheel. In other words, the relationship between the second braking assembly and other structures such as the support strut, wheel holder, etc. is the same or similar to the relationship between the first braking assembly and other structures such as the support strut, wheel holder, etc. The present invention preferably includes two braking assemblies. However, to protect the spirit of the present invention, the present invention includes only one braking assembly, given the equivalence of these two braking assemblies. When the first wiring 41 pushes the first brake pad 43 to become separated from the wheel 32, the wheel 32 slides. A first spring 42 is provided between the first brake pad 41 and the wheel holder 31 for flexibly stretching or recovering the first brake pad 41 and the wheel holder 31. When releasing the first push bar 21, the first spring 42 restores the contact of the first brake pad 43 with the wheel 32, thereby stopping the pushcart 1. On the contrary, when pressing the first push bar 21, the first spring 42 becomes pressed by the first brake pad 43 and becomes separated from the wheel 32, thereby moving the pushcart 1. Preferably, the first braking assembly 40 includes a connecting assembly 44, which is connected to the first wiring 41 and the first brake pad 43. A third spring 45 is provided on top of the connecting assembly 44 to recover the contact of the first brake pad 43 with the wheel 32.

The pivotal member 50, which is pivotally connected to the first push bar 23, is provided with a slot 52 on the eccentric position for being connected to the first wiring 41. In this way, when pressing the first push bar 23, the pivotal member 50 rotates, such that the first wiring 41 controls the movement of the first brake pad 43. Preferably, the pivotal member 50 is an eccentric sleeve 51, which is pivotally connected to the first push bar 23. The slot 52 is provided on an eccentric location of the eccentric sleeve 51, such that the slot 52 is pivotally connected to the first wiring 41.

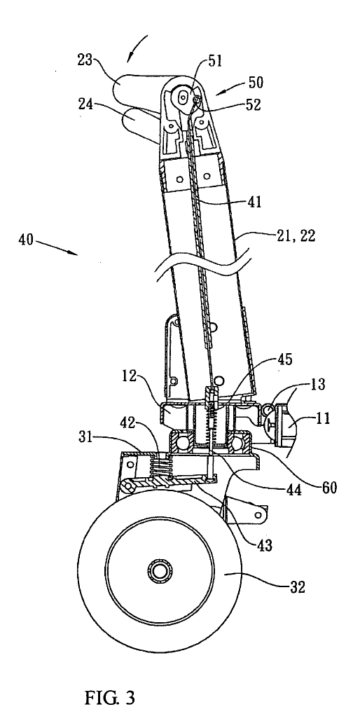

Referring to FIG. 3, when pressing the first push bar 23, the user can grasp the first push bar 23 and the second push bar 24 together, such that the first push bar 23 becomes near to the second push bar 24, thereby pushing the push bars in an effort-saving manner. Consequently, when pressing the first push bar 23, the eccentric sleeve 51, which is pivotally connected to the two ends of the first push bar 23, rotates, thus actuating the upward stretch of the first wiring 44. Additionally, the first wiring 41 pulls up the connecting assembly 44, such that the first brake pad 43 is pulled away from the surface of the wheel 32, thus moving the pushcart 1. When the first brake pad 43, the first wiring 41 and the connecting assembly 44 are pulled upward, this will apply a force on the first spring 42 and then stretch the third spring 45 (See FIG. 3). While braking the pushcart 1 and releasing the first push bar 23, this can restore the contact of the first brake pad 43 with the wheel 32, due to the restoring force exerted by the first spring 42 and the third spring 45. In this way, the wheel 32 is unable to rotate and finally stops (See FIG. 2).

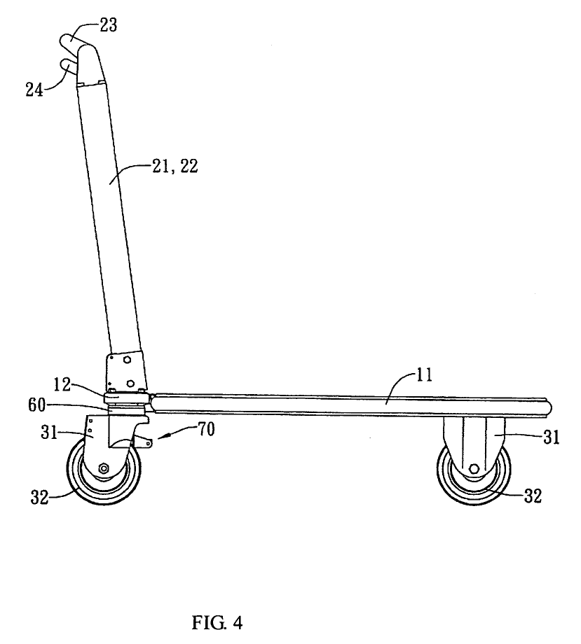

Referring to FIGS. 4 & 5, the pushcart 1 is capable of braking, folding and storing or stretching. To fold and store the pushcart 1, the user steps on the pedal assembly 70. By pushing the push bar assembly 20 forward, the pushcart 1 is folded and stored. By using the pivotal assembly 13, the first portion 12 and the second portion 11 of the base plate 10 are folded and stored into a rectangular form, thereby saving space for storing the pushcart 1.

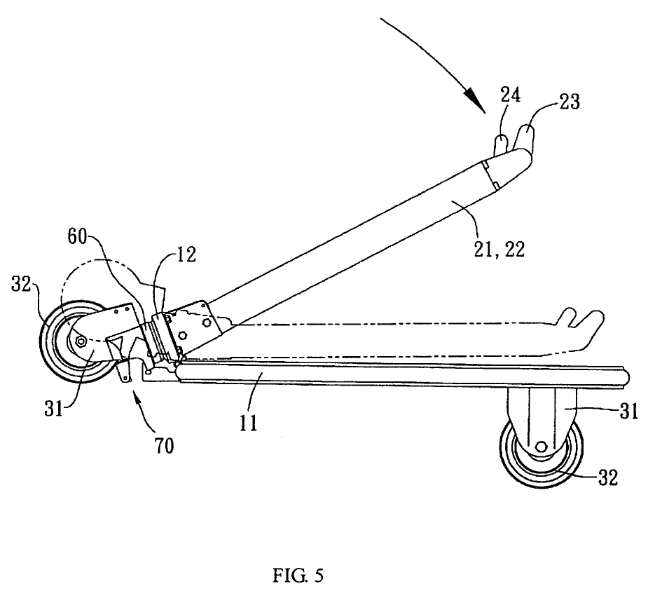

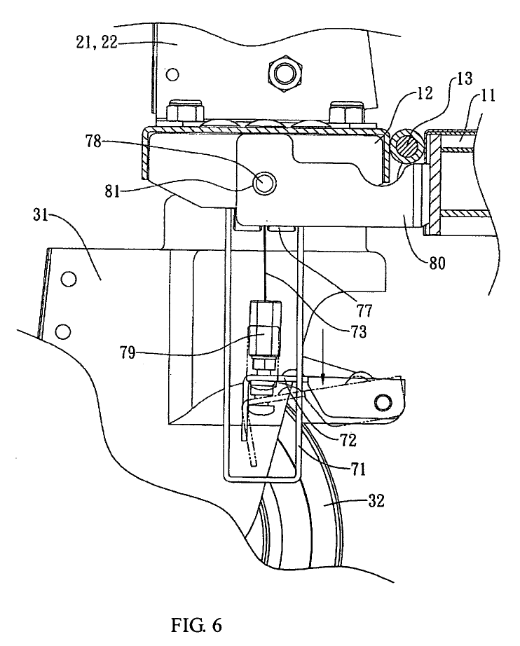

Referring to FIG. 6, a locating member 80, which is disposed on the second portion 11 of the base plate 10, is located near to the first portion 12. The locating member 80, having an opening 81, is extended below the first portion 12 of the base plate 10, while the pedal assembly 70 has a locating lock 78 disposed on the pedal assembly 70 of the first portion 12 of the base plate 10. When the locating lock 78 is inserted into the opening 81 of the locating member 80, the first portion 12 and the second portion 11 of the base plate 10 are then fixed. On the contrary, while stepping on the pedal assembly 70, the locating lock 78 becomes separated from the opening 81 of the locating member 80, such that the first portion 12 and the second portion 11 of the base plate are folded and stored by using the pivotal assembly 13 (See FIG. 5).

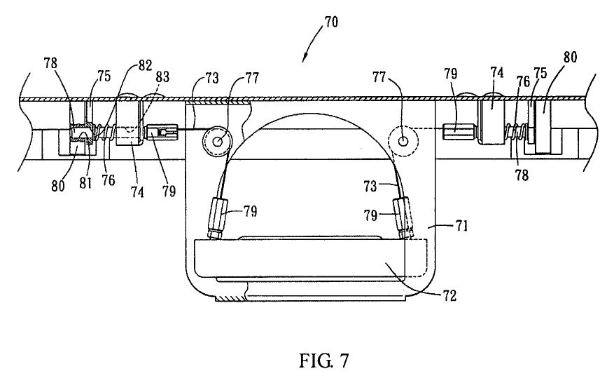

Referring to FIG. 7, the pedal assembly 70 includes a pedal frame 71, a pedal 72, a pair of third wirings 73, a set of first struts 74, a set of second struts 75, a set of second springs 76, a set of rollers 77 and a set of locating locks 78. Also, an end of the pedal 72 is pivotally connected to the pedal frame 71. Preferably, the pedal frame 71 includes a set of slides, such that the pedal 72 can be inserted into the slides for forward and backward sliding. The pedal frame 71 is provided with a pair of rollers 77, while the two ends of the third wiring 73 are respectively connected to the pedal 72 and the locating lock 78. Additionally, the third wirings 73 slide along with the rollers 77, such that the third wirings 73 smoothly slide to and fro. Preferably, a locking member 79 is additionally disposed at the connection of the third wiring 73 to the pedal 72 and the locating lock 78, so as to reinforce their connection. The first strut 74 and the second strut 75, which are both fixed on a bottom of the first portion 12 of the base plate, are respectively provided with an opening 83 and an opening 82, thereby locating the locating lock 78. Additionally, a fourth spring 76 is disposed between the first strut 74 and the second strut 75. An end of the fourth spring 76 is fixed on the locating lock 78. In this way, when a force is applied on the first strut 74 and the second strut 75 by using the locating lock 78, the second spring 76 restores the locating lock 78 to its original location. A protruding portion of the locating lock 78 becomes inserted into the opening 81 of the locating member 80 for locating purpose. The first strut 74 and the second strut 75 of the first portion 12 of the base plate 10 as well as the locating member 80 of the second portion 11 of the base plate 10 become located by using the locating lock 78 (See in FIG. 7).

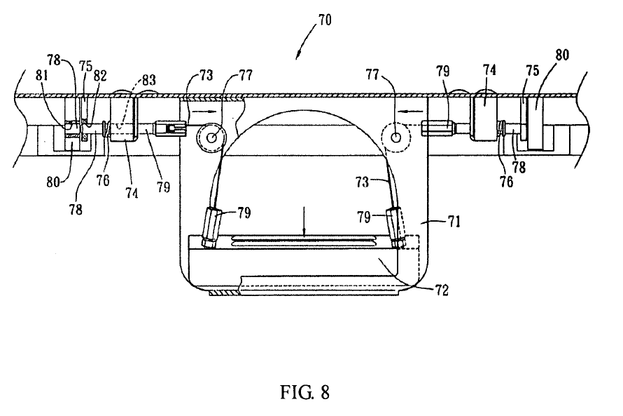

Referring to FIG. 8, when stepping on the pedal 72, the pedal 72 pulls the third wiring 73, thereby causing the rollers 77 to slide. In this way, by using the third wiring 73, the pair of locating locks 78 is pulled away from the opening 81 of the locating member 80, such that a force is applied on the fourth spring 76 of the locating lock 78. In this way, the user can push the push bar assembly 20, thus folding and storing the first portion 12 and the second portion 11 of the base plate 10. To use the folded pushcart 1 again, the user stretches the pushcart 1 by pushing the push bar assembly 20 and then steps on the pedal 72, such that the locating lock 78 slides toward the rollers 77. When the pushcart 1 is completely stretched, the user releases the pedal 72, such that the locating lock 78 becomes inserted into the opening 81 of the locating member 80 again, thereby stretching the pushcart 1.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pushcart, comprising:
a base plate, for carrying an object;
a plurality of wheel assemblies, disposed below said base plate and comprising a plurality of wheels;
a first support strut and a second support strut, being hollow and disposed on two ends of said base plate;
a first push bar, disposed between said first support strut and said second support strut; and
a first braking assembly, having at least a first wiring and a first spring; said first wiring having a first end disposed on said first push bar, and a second end connecting to a first brake pad; said first wiring disposed inside said hollow first support strut; and said first spring disposed between said first brake pad and said wheel assembly.

2. The pushcart as claimed in claim 1, further comprising a second braking assembly, having at least a second wiring and a second spring; said second wiring having a third end disposed on said first push bar, and a fourth end connecting to a second brake pad; said second wiring disposed inside said hollow second support strut; and said second spring disposed between said second brake pad and said wheel assembly.

3. The pushcart as claimed in claim 1, further comprising a pivotal member, which is pivotally connected to said first push bar and is connected to said first wiring thereon.

4. The pushcart as claimed in claim 1, wherein said pivotal member is an eccentric sleeve pivotally connected to said first push bar, and a slot is provided on an eccentric location of said eccentric sleeve, thereby being pivotally connected to said first wiring.

5. The pushcart as claimed in claim 1, wherein said first braking assembly further comprises a connecting assembly for connecting said first wiring and said first brake pad.

6. The pushcart as claimed in claim 1, wherein said wheel assembly comprises a wheel holder, such that said first spring is disposed between said first brake pad and said wheel assembly.

7. The pushcart as claimed in claim 6, wherein said first brake pad is disposed on said wheel holder of said wheel assembly.

8. The pushcart as claimed in claim 1, wherein said first brake pad is made of plastics.

9. The pushcart as claimed in claim 1, further comprising a second push bar, disposed between said first support strut and said second support strut.

10. The pushcart as claimed in claim 1, wherein at least one bearing is disposed between said wheel assembly and said base plate.

11. The pushcart as claimed in claim 1, wherein said base plate, having a first portion and a second portion, is pivotally connected to said first portion and said second portion through a pivotal assembly.

12. The pushcart as claimed in claim 11, wherein said pivotal member is a hinge.

13. The pushcart as claimed in claim 11, further comprising a pedal assembly, disposed on said first portion of said base plate; said pedal assembly further comprising:
a locating member, disposed below said base plate;
a control member, disposed below said base plate; and
a locating lock, connected to said control member, which controls the locating of said locating lock on said locating member, such that said first portion and said second portion of said base plate are folded through said pivotal assembly.

14. The pushcart as claimed in claim 13 wherein said locating member, which is disposed on said second portion, is extended below said first portion; said locating member having an opening for inserting into said locating lock.

15. The pushcart as claimed in claim 13 wherein said pedal assembly further comprises a pedal frame; said control member further comprising:
a pedal, having an end pivotally connected to said pedal frame; and
a third wiring, having a first end connecting to said pedal; and a second end connecting to said locating lock.

16. The pushcart as claimed in claim 13, further comprising:
a first strut, disposed on below said first portion and comprising an opening for inserting into said locating lock; and
a second strut, disposed below said first portion, and comprising an opening for inserting into said locating lock.

17. The pushcart as claimed in claim 13, wherein said locating lock further comprises a fourth spring, disposed between said first strut and said second strut.

18. The pushcart as claimed in claim 13, wherein said pedal assembly further comprises a roller for said third wiring to slide along with.
